(19) United States
(12) Patent Application Publication
(10) Pub. No.: US 2006/0103681 A1
(43) Pub. Date: May 18, 2006

(54) Display apparatus and control method thereof

(75) Inventors: Seung-won Choi, Seoul (KR); Jong-hwa Bae, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/266,219

(22) Filed: Nov. 4, 2005

(30) Foreign Application Priority Data
Nov. 17, 2004 (KR) 2004-0094323

(51) Int. Cl. G09G 5/00

(52) U.S. Cl. 345/661

(57) ABSTRACT

A display apparatus with a display part to display a picture thereon, including a user interface (UI) generator to provide an interface screen for setting an overscan region of a picture displayed on the display part; a user input part used for selection/input of a user; and a controller to control the UI generator to display the interface screen for setting the overscan region onto the display part when a user overscan setting function is selected through the user input part. Thus, an optimum overscan region is effectively set through an overscan setting interface screen, thereby displaying an optimum picture.

### CROSS-REFERENCE TO RELATED APPLICATIONS

This application claims the benefit of Korean Patent Application No. 2004-0094323, filed on Nov. 17, 2004, in the Korean Intellectual Property Office, the disclosure of which is incorporated herein by reference.

### BACKGROUND OF THE INVENTION

1. Field of the Invention

The present invention relates to a display apparatus and a control method thereof, and more particularly, to a display apparatus and a control method thereof, in which an optimum overscan region is effectively set through an overscan setting interface screen, thereby displaying an optimum picture.

2. Description of the Related Art

Generally, a display apparatus comprises a display part to display a picture thereon; a signal processor to process an input video signal; a scaler to convert the video signal outputted from the signal processor to have a format proper for the display part; and a controller to control the display part, the signal processor, and the scaler.

As for the display apparatus, a projector has an overscan function that displays a picture based on the input video signal without a garbage area (e.g., a border area), and selectively enables/disables the overscan function.

Thus, when the overscan function is not enabled, such a display apparatus displays an entire picture based on the input video signal. Here, when the entire displayed picture contains a garbage area in an outline thereof, the garbage area can be removed by enabling the overscan function. When the overscan function is enabled, the display part of the display apparatus displays only a picture within an overscan region previously set in the entire picture based on the input video signal, thereby removing the garbage area.

However, in the conventional display apparatus, a scan region is previously set and has an invariable value, so that not only the garbage area but also a desired picture may not be displayed when the overscan function is enabled.

### SUMMARY OF THE INVENTION

Accordingly, it is an aspect of the present invention to provide a display apparatus and a control method thereof, in which an optimum overscan region is effectively set through an overscan setting interface screen, thereby displaying an optimum picture.

The foregoing and/or other aspects of the present invention are also achieved by providing a display apparatus with a display part to display a picture thereon, comprising a UI generator to provide an interface screen for setting an overscan region of a picture displayed on the display part; a user input part used for selection/input of a user; and a controller to control the UI generator to display the interface screen for setting the overscan region onto the display part when a user overscan setting function is selected through the user input part.

According to an aspect of the present invention, the interface screen comprises an overscan setting line to visually indicate the overscan region on the display part.

According to an aspect of the present invention, the display apparatus further comprises a scaler to convert an input video signal to have a format suitable for the display part, wherein the controller controls the scaler to display an entire picture based on the input video signal onto the display part and controls the UI generator to display the interface screen for setting the overscan region onto the display part when the user overscan setting function is selected through the user input part.

According to an aspect of the present invention, the controller controls the UI generator to visually change at least one of the size and the position of the overscan region on the interface screen in correspondence to the input of the user input part.

According to an aspect of the present invention, the controller stores user overscan region information containing at least one of the size and the position of the overscan region changed by operating the interface screen, when a user overscan region save is selected through the user input part.

According to an aspect of the present invention, the controller controls the scaler to process a video signal corresponding to the overscan region on the basis of the stored user overscan region information and to display a picture corresponding to the overscan region onto the display part.

According to an aspect of the present invention, the controller controls the scaler to display the entire picture based on the input video signal onto the display part when the overscan function is disabled through the user input part.

The foregoing and/or other aspects of the present invention are also achieved by providing a method of controlling a display apparatus comprising a display part, and a scaler to convert an input video signal to have a format suitable for the display part, the method comprising selecting a user overscan setting function; displaying an interface screen to set an overscan region on the display part when the user overscan setting function is selected; and changing at least one of the size and the position of the overscan region through the interface screen.

According to an aspect of the present invention, the interface screen comprises an overscan setting line for visually indicating the overscan region on the display part.

According to an aspect of the present invention, the displaying the interface screen comprises displaying an entire picture based on the input video signal on the display part when the user overscan setting function is selected.

According to an aspect of the present invention, the method further comprises determining whether a changed user overscan region save is selected; and storing information about at least one of the size and the position of the overscan region changed through the interface screen when the user overscan region save is selected.

According to an aspect of the present invention, the method further comprises displaying a picture corresponding to the overscan region on the display part on the basis of the stored user overscan region information.

According to an aspect of the present invention, the displaying the interface screen comprises displaying an entire picture based on the input video signal on the display part when the user overscan setting function is selected.

### BRIEF DESCRIPTION OF THE DRAWINGS

The above and/or other aspects of the present invention will become apparent and more readily appreciated from the following description of exemplary embodiments, taken in conjunction with the accompanying drawings of which:

FIG. 1 is a control block diagram of a display apparatus according to an exemplary embodiment of the present invention;

FIGS. 2 and 3 are control flowcharts of the display apparatus according to an exemplary embodiment of the present invention; and

FIGS. 4A and 4B illustrate interface screens to set a user overscan region of the display apparatus according to an exemplary embodiment of the present invention.

### DETAILED DESCRIPTION OF EXEMPLARY EMBODIMENTS OF THE PRESENT INVENTION

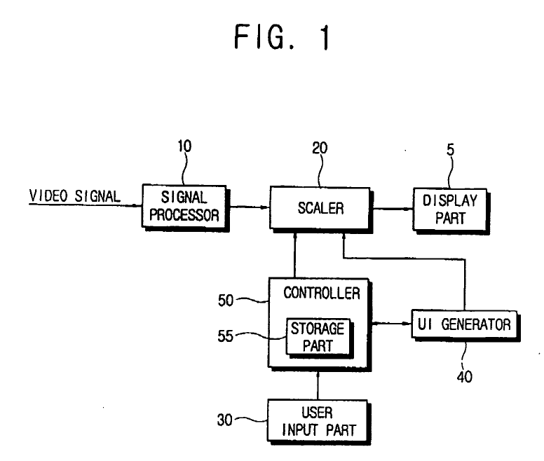

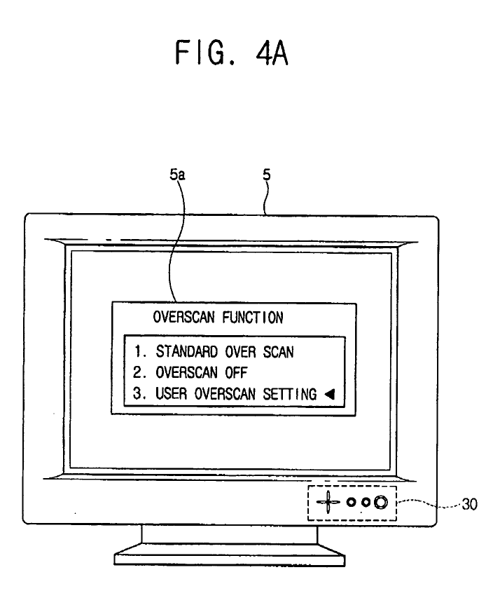

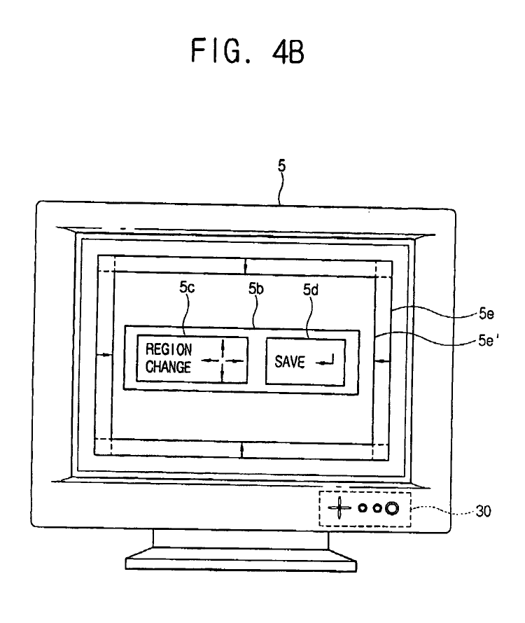

Reference will now be made in detail to exemplary embodiments of the present invention, examples of which are illustrated in the accompanying drawings, wherein like reference numerals refer to like elements throughout. The embodiments are described below in order to explain the present invention with reference to FIGS. 1, 4A and 4B.

As shown in FIG. 1, a display apparatus according to an exemplary embodiment of the present invention comprises a display part 5, a signal processor 10, a scaler 20, a user input part 30, a user interface (UI) generator 40, and a controller 50.

The display part 5 receives a video signal from the scaler 20 and displays a picture. The display part 5 comprises a display panel (not shown) to display a picture thereon, and a panel driver (not shown) to process the video signal received from the scaler 20 and drive the display panel to display a picture.

The signal processor 10 processes the input video signal to be convertible by the scaler 20. Here, the signal processor 10 may comprise a transition minimized differential signaling (TMDS) receiver (not shown), an analog/digital (A/D) converter (not shown), a video decoder (not shown), a tuner (not shown), etc.

The TMDS receiver divides a digital video signal such as a digital video interface (DVI) signal or the like inputted from the outside through a digital connection terminal (not shown) into a red, green and blue (RGB) signal and a horizontal/vertical (H/V) synchronization signal, thereby outputting the RGB signal and the H/V synchronization signal to the scaler 20. The A/D converter (not shown) converts an analog video signal such as a component signal, a personal computer (PC) signal, or the like into a digital video signal, thereby outputting the digital video signal to the scaler 20. The video decoder decodes the analog video signal such as a composite video broadcast signal (CVBS), an S-video signal, or the like inputted through an analog connection terminal (not shown), thereby outputting the decoded video signal to the scaler 20. The tuner receives a radio frequency (RF) broadcast signal through an antenna (not shown) or the like, thereby outputting the RF broadcast signal to the video decoder.

The scaler 20 converts the input video signal to have a format suitable for the display part 5. Here, the scaler 20 is controlled by the controller 50 to process the video signal inputted from the signal processor 10, thereby displaying an entire picture corresponding to the video signal on the display part 5 or displaying a picture corresponding to an overscan region on the display part 5.

The user input part 30 outputs a key signal to the controller 50 according to an operation of a user. As shown in FIGS. 4A and 4B, the user input part 30, according to an exemplary embodiment of the present invention, comprises a control button placed in a front of the display apparatus, and a key signal generator (not shown) to generate the key signal in response to a keying operation of the control button. At this time, the user input part 30 may include a mouse (not shown), a keyboard (not shown), a wireless remote controller (not shown), etc., which are used as input units separately coupled to the display apparatus. Here, when a user operates the control button, the key signal generator outputs the key signal corresponding to the keying operation of the control button to the controller 50. Thus, the controller 50 controls the scaler 20, the UI generator 40 and the like in response to the key signal received from the key signal generator.

The UI generator 40 provides interface screens 5b, 5c, 5d and 5e (refer to FIG. 4B) onto the display part 5, thereby allowing a user to set the overscan region. Here, a video signal generated from the UI generator 40 in correspondence to the interface screen for setting the overscan region is mixed with the video signal outputted from the scaler 20, thereby being displayed as a picture on the display part 5.

Here, the interface screen includes an overscan setting line 5e to visually display the overscan region. Thus, a user operates the user input part 30 and sets a predetermined picture region to be removed from the entire picture as the overscan setting line 5e. According to an exemplary embodiment of the present invention, the UI generator 40 may include an on screen display (OSD) generator to display an OSD screen. In this case, the UI generator 40 may display a setting OSD screen 5a for setting an overscan function according to a user's operations, via the user input part 30.

The controller 50 controls the scaler 20 to display the entire picture (i.e., overscan off) based on the input video signal when user overscan setting function is selected by the user's operation of the user input part 30 (refer to FIG. 4A), and controls the UI generator 40 to display the interface screen for setting the overscan region on the entire picture displayed on the display part 5.

Here, the controller 50 controls the UI generator 40 to visually change at least one of the size and the position of the overscan setting line 5e into the overscan setting line 5e′ for indicating the overscan region on the interface screen in correspondence to the key signal of the user input part 30.

Further, the controller 50 controls a storage part 55 to store therein user overscan region information about at least one of the size and the position of the changed overscan region 5e′ when a user overscan region save 5d is selected through the user input part 30 (refer to FIG. 4B). Thus, the controller 50 stores the changed user overscan region information and at the same time controls the scaler 20 to process the video signal only corresponding to the overscan region 5e′ based on the stored user overscan region information.

Hence, a picture corresponding to the overscan region 5e′ is displayed on an entire screen of the display part 5.

Here, the storage part 55 generally stores standard overscan region information. Thus, when standard overscan function is selected through the user input part 30 (refer to FIG. 4A), the controller 50 preferably controls the scaler 20 to directly display a picture corresponding to the overscan region based on the previously stored standard overscan region information as the entire picture of the display part 5 without separately providing the interface screen for setting the overscan region.

On the other hand, when an overscan off (refer to ‘2’ of FIG. 4A) is selected through the user input part 30, the controller 50 controls the scaler 20 to display the entire picture based on the input video signal on the display part 5.

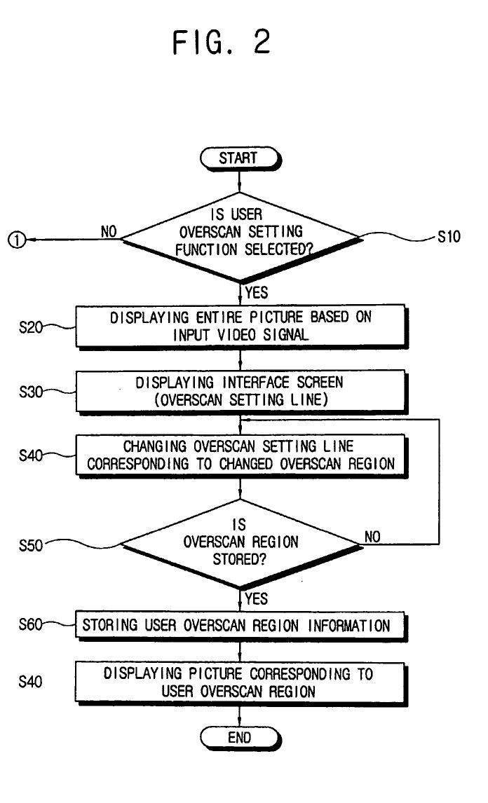

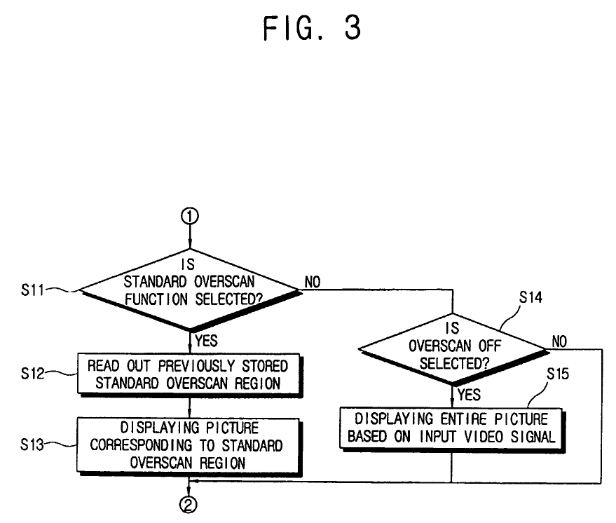

Hereinbelow, operations of the display apparatus according to an exemplary embodiment of the present invention will be described with reference to FIGS. 2 and 3.

First, at operation S10, the controller 50 determines whether the user overscan setting function (refer to ‘3’ of FIG. 4A) is selected through the user input part 30. When the user overscan setting function is selected, at operation S20, the controller 50 controls the scaler 20 to display the entire picture based on the input video signal onto the display part 5. At this time, the controller 50 controls the scaler 20 to display the entire picture based on the input video signal onto the display part 5, regardless of whether the overscan function is enabled or disabled before the user overscan setting function is selected. Then, at operation S30, the controller 50 controls the UI generator 40 to display the interface screen 5b, 5c, 5d and 5e on the currently displayed entire picture (refer to FIG. 4B). At this time, a user operates the user input part 30 and changes the overscan setting line 5e to set a proper overscan region while looking at the entire picture displayed on the display part 5. Then, at operation S40, the controller 50 controls the UI generator 40 to visually change the overscan setting line 5e into a predetermined overscan setting line 5e′ in correspondence to the operation of the user input part 30. Here, the overscan setting line is movable up, down, right and left.

Thereafter, at operation S50, the controller 50 determines whether the user overscan region save 5d is selected through the user input part 30 (refer to FIG. 4B). When the user overscan region save 5d is selected, at operation S60, the controller 50 controls the storage part 55 to store the user overscan region information containing at least one of the size and the position of the changed overscan setting line 5e′. At operation S70, the controller 50 stores the changed user overscan region information, and at the same time controls the scaler 20 to display a picture corresponding to the overscan region 5e′ on the entire screen of the display part 5 on the basis of the stored user overscan region information.

Thus, in the display apparatus according to an exemplary embodiment of the present invention, a user can set the overscan region as he or she wants while looking at the overscan setting line if the overscan function is enabled. Thus, in the display apparatus according to an exemplary embodiment of the present invention, the entire picture based on the input video signal is displayed on the display part 5, and the overscan setting line for setting the overscan region is displayed on the entire displayed picture, so that a user can easily set the best overscan region while looking at the entire picture.

On the other hand, when the user overscan setting function (refer to ‘3’ of FIG. 4A) is not selected in the operation S10, at operation S11, the controller 50 determines whether the standard overscan function (refer to ‘1’ of FIG. 4A) is selected or not. When the standard overscan function is selected, at operation S12, the controller 50 reads out the standard overscan region information (e.g., 80% of the entire picture) previously stored in the storage part 55. Then, at operation S13, the controller 50 controls the scaler 20 to display a picture corresponding to the standard overscan region onto the entire screen of the display part 5 on the basis of the standard overscan region information.

Further, when the standard overscan function (refer to ‘1’ of FIG. 4A) is not selected in the operation S11, at operation S14, the controller 50 determines whether the overscan off (refer to ‘2’ of FIG. 4A) is selected or not. When the overscan off is selected, at operation S15, the controller 50 controls the scaler 20 to display the entire picture based on the input video signal onto the display part 5.

Thus, in the display apparatus according to an exemplary embodiment of the present invention, a user can change/set the overscan region and adjust a picture displayed on the display part 5. Further, while a user changes the overscan region, the display apparatus according to an exemplary embodiment of the present invention displays the entire picture based on the input video signal and then displays the interface screen on the entire picture, wherein the interface screen includes the overscan setting line for indicating the overscan region. Therefore, a user can effectively set the overscan region to not contain a garbage area by changing the overscan setting line displayed on the entire picture.

As described above, an exemplary embodiment of the present invention provides a display apparatus and a control method thereof, in which an optimum overscan region is effectively set through an interface screen for setting an overscan region, thereby displaying an optimum picture.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus with a display part to display a picture thereon, comprising:
a user interface (UI) generator to provide an interface screen for setting an overscan region of a picture displayed on the display part;
a user input part used for selection/input of a user; and
a controller to control the UI generator to display the interface screen for setting the overscan region onto the display part if a user overscan setting function is selected through the user input part.

2. The display apparatus according to claim 1, wherein the interface screen comprises an overscan setting line to visually indicate the overscan region on the display part.

3. The display apparatus according to claim 2, further comprising a scaler to convert an input video signal to have a format suitable for the display part, wherein
the controller controls the scaler to display an entire picture based on the input video signal onto the display part and controls the UI generator to display the interface screen for setting the overscan region onto the display part if the user overscan setting function is selected through the user input part.

4. The display apparatus according to claim 3, wherein the controller controls the UI generator to visually change at least one of the size and the position of the overscan region on the interface screen based on the input from the user input part.

5. The display apparatus according to claim 4, wherein the controller stores user overscan region information containing said at least one of the size and the position of the overscan region changed by operating the interface screen, if a user overscan region save is selected through the user input part.

6. The display apparatus according to claim 5, wherein the controller controls the scaler to process a video signal corresponding to the overscan region based on the stored user overscan region information and to display a picture corresponding to the overscan region onto the display part.

7. The display apparatus according to claim 6, wherein the controller controls the scaler to display the entire picture based on the input video signal onto the display part when the overscan function is disabled through the user input part.

8. The display apparatus according to claim 1, further comprising a scaler to convert an input video signal to have a format suitable for the display part, wherein
the controller controls the scaler to display an entire picture based on the input video signal onto the display part and controls the UI generator to display the interface screen for setting the overscan region onto the display part if the user overscan setting function is selected through the user input part.

9. The display apparatus according to claim 8, wherein the controller controls the UI generator to visually change at least one of the size and the position of the overscan region on the interface screen based on the input from the user input part.

10. The display apparatus according to claim 9, wherein the controller stores user overscan region information containing said at least one of the size and the position of the overscan region changed by operating the interface screen, if a user overscan region save is selected through the user input part.

11. The display apparatus according to claim 10, wherein the controller controls the scaler to process a video signal corresponding to the overscan region based on the stored user overscan region information and to display a picture corresponding to the overscan region onto the display part.

12. The display apparatus according to claim 11, wherein the controller controls the scaler to display the entire picture based on the input video signal onto the display part when the overscan function is disabled through the user input part.

13. A method of controlling a display apparatus comprising a display part and a scaler to convert an input video signal to have a format suitable for the display part, the method comprising:
selecting a user overscan setting function;
displaying an interface screen to set an overscan region on the display part if the user overscan setting function is selected; and
changing at least one of the size and the position of the overscan region through the interface screen.

14. The method according to claim 13, wherein the interface screen comprises an overscan setting line for visually indicating the overscan region on the display part.

15. The method according to claim 14, wherein the displaying of the interface screen comprises displaying an entire picture based on the input video signal on the display part if the user overscan setting function is selected.

16. The method according to claim 15, further comprising:
determining whether a changed user overscan region save is selected; and
storing information about at least one of the size and the position of the overscan region changed through the interface screen if the user overscan region save is selected.

17. The method according to claim 16, further comprising displaying a picture corresponding to the overscan region on the display part based on the stored user overscan region information.

18. The method according to claim 13, wherein the displaying of the interface screen comprises displaying an entire picture based on the input video signal on the display part if the user overscan setting function is selected.

19. The method according to claim 18, further comprising:
determining whether a changed user overscan region save is selected; and
storing information about at least one of the size and the position of the overscan region changed through the interface screen if the user overscan region save is selected.

20. The method according to claim 19, further comprising displaying a picture corresponding to the overscan region on the display part based on the stored user overscan region information.
